(19) United States
(12) Patent Application Publication
(10) Pub. No.: US 2014/0008985 A1
(43) Pub. Date: Jan. 9, 2014

(54) METHOD AND SYSTEM FOR CONTROL OF ENERGY STORAGE DEVICES

(71) Applicants: Maksim Subbotin, Menlo Park, CA (US); Nalin Chaturvedi, Sunnyvale, CA (US); Ashish Samuel Krupadanam, Cupertino, CA (US); Jasim Ahmed, Mountain View, CA (US)

(72) Inventors: Maksim Subbotin, Menlo Park, CA (US); Nalin Chaturvedi, Sunnyvale, CA (US); Ashish Samuel Krupadanam, Cupertino, CA (US); Jasim Ahmed, Mountain View, CA (US)

(73) Assignee: Robert Bosh GmbH, Stuttgart (DE)

(21) Appl. No.: 13/542,692

(22) Filed: Jul. 6, 2012

(51) Int. Cl. H02J 1/00

(52) U.S. Cl. 307/77

(57) ABSTRACT

An energy storage control system and method is disclosed. The energy storage control system can include a controller, a circuit defining a plurality of electrical current paths between an input and an output, and a first energy storage device and a second energy storage device electrically coupled in series to one another between the input and output. The control system can also include a first switch device electrically coupled in parallel to the first energy storage device and a second switch device electrically coupled in parallel to the second energy storage device. The controller can be in electrical communication with the first energy storage device and the second energy storage device. The first switch device and second switch device can be operably controlled by the controller.

### FIELD OF THE DISCLOSURE

The present disclosure relates to an energy storage management system, and particularly to a method and system for controlling a current path through the plurality of energy storage devices.

### BACKGROUND

An energy storage system can be any electronic system that manages energy storage devices such as electrochemical batteries, electrochemical flow batteries, energy storage flywheels, or other devices that can accumulate and/or generate electrical energy. A battery management system, for example, can be an electronic system that manages a rechargeable battery (i.e., cell or battery pack) such as monitoring its state, protecting the battery, controlling its environment, etc. The system can monitor temperature, voltage, state of charge, current, among other characteristics. These systems generally monitor the condition of an individual battery to ensure the battery performs as expected.

Energy storage systems, however, can include more than a single energy storage device. For instance, an energy system can include a plurality of electrochemical flow batteries connected in series to one another. Individual battery cells connected in series can serve as an energy storage system accumulating, storing or generating electric energy depending on a state of the system. Individual battery cells in the system may vary from one another, however, in their individual characteristics due to imperfections in the manufacturing process. Also, there can be variations in characteristics of elements comprising individual cells such as electrolyte pumps, sensors, etc. In addition, the system of energy storage devices connected in series may be distributed in space such that individual devices may experience different environmental conditions, e.g., temperature. Due to these variations between batteries, there can be differences in operational characteristics of these devices that can significantly affect performance and safety of the system.

It would therefore be desirable to have a system and method for managing energy storage devices within a system to compensate for the differences between different devices and the surrounding environment of each. Such a system and/or method could provide the means of controlling individual devices connected in series and electrically enabling or disabling them with minimal impact on the rest of the system.

### SUMMARY

An exemplary embodiment of an energy storage control system is disclosed. The energy storage control system includes a controller, a circuit defining a plurality of electrical current paths between an input and an output, and a first energy storage device and a second energy storage device electrically coupled in series to one another between the input and output. The control system also includes a first switch device electrically coupled in parallel to the first energy storage device and a second switch device electrically coupled in parallel to the second energy storage device. The controller is in electrical communication with the first energy storage device and the second energy storage device. The first switch device and second switch device are operably controlled by the controller.

In one aspect, the control system can include a first current path defined between the input and output and in electrical communication with the first energy storage device and second energy storage device. The control system can also include a second current path electrically coupled between the first current path and one of the first switch device and second switch device. In another aspect, the first energy storage device and second energy storage device can be configured to receive a current passing through the first current path when the first switch device and second switch device are disposed in an open position. In an alternative aspect, the first switch device or the second switch device can be configured to receive a current passing through the second current path.

In this embodiment, when the first switch device is disposed in a closed position, the first energy storage device can be electrically disconnected from the input. Here, a current can pass through the second current path. Alternatively, when the second switch device is disposed in a closed position, the second energy storage device can be electrically disconnected from the input. In this configuration, a current can pass through the second current path.

The control system can further include a third energy storage device electrically coupled in series with the first and second energy storage devices and a third switch device electrically coupled in parallel to the third energy storage device. Alternatively, a third switch device can be electrically coupled in series with one of the first energy storage device and second energy storage device. In this embodiment, the first and second energy storage devices may comprise an electrochemical battery, an electrochemical flow battery, an energy storage flywheel, or any other device that accumulates and/or generates electrical energy.

A different embodiment of an energy storage management system is disclosed which includes a controller, a circuit including an input and an output, and a first energy storage device and a second energy storage device electrically coupled in series to one another between the input and output. The system also includes a first and second switch electrically coupled in parallel to the first and second energy storage devices. A third switch is electrically coupled in series with the first energy storage device and a fourth switch is electrically coupled in series with the second energy storage device. The controller is in electrical communication with the first energy storage device and the second energy storage device. In addition, the first, second, and third switches are operably controlled between open and closed positions by the controller.

In one aspect of this embodiment, the control system can include a first electrical current path defined in the circuit. Here, the input, output, first energy storage device, second energy storage device, third switch, and fourth switch are in electrical communication with one another along the first electrical current path. A current can pass through the first electrical current path when the third and fourth switches are disposed in the closed position and the first and second switches are disposed in the open position.

In another aspect, the control system can include a second electrical current path defined in the circuit. Here, a current can pass through the second electrical current path when (a) the first and fourth switches are in closed positions and the second and third switches are in open positions; or (b) the second and third switches are in closed positions and the first and fourth switches are in open positions; or (c) the first and second switches are in closed positions and the third and fourth switches are in open positions.

Another embodiment of a method of controlling an energy storage device system is disclosed. The method includes providing a circuit having an input and an output, a first and second energy storage device electrically coupled to one another in series between the input and output, and a first and second switch electrically coupled in parallel with the first and second energy storage devices. The method also includes passing a current through an electrical current path from the input to the output and receiving information about each of the first and second energy storage devices. A determination is made whether to change the current path through which the current passes in response to the information received.

In one aspect, the method can include changing the current path of the current in response to the information received. As such, changing the current path can be achieved by opening or closing the first or second switch. In another aspect, the method can include receiving the current by the first and second energy storage devices and storing electrical energy in the first and second energy storage devices until the amount of stored energy in at least one of the first and second energy storage devices reaches a desired amount. A determination can be made that the amount of stored energy in at least one of the first and second energy storage devices has reached the desired amount such that the first or second switch can be controlled to electrically disable the energy storage device having reached its desired energy storage amount from receiving the current. In this aspect, the method can further include passing the current through an alternative current path.

The energy storage control system and method of control can effectively manage energy storage devices within a system to compensate for the differences between different devices and the surrounding environment of each. Such a system and/or method is able to control individual devices connected in series and electrically enable or disable them with minimal impact on the rest of the system. The system and/or method can be utilized for a network of energy storage devices and switch devices to control the amount of current being passed therethrough. The system can incorporate switch devices in parallel and series with the energy storage devices to enable better control of the system.

### BRIEF DESCRIPTION OF THE DRAWINGS

The above-mentioned aspects of the present invention and the manner of obtaining them will become more apparent and the invention itself will be better understood by reference to the following description of the embodiments of the invention, taken in conjunction with the accompanying drawings, wherein:

FIG. 1 is a schematic of an energy storage device control system;

FIG. 2 is a schematic of one embodiment of the energy storage device control system of FIG. 1;

FIG. 3 is a schematic of a different embodiment of the energy storage device control system of FIG. 2;

FIG. 4 is a schematic of another embodiment of the energy storage device control system of FIG. 1; and

FIG. 5 is a schematic of a further embodiment of the energy storage device control system of FIG. 4.

Corresponding reference numerals are used to indicate corresponding parts throughout the several views.

### DETAILED DESCRIPTION

The present disclosure provides embodiments of a method and hardware system structured to control a number of energy storage devices coupled to one another along an electrical current path. These embodiments can provide means for disabling individual devices coupled in series with the other energy storage devices in order to remove one or more disabled devices from the electrical current path during charge, discharge, or any other state of the system. The method can be utilized for controlling the flow of electric current through any energy storage system comprised of individual storage devices such as, for example, electrochemical batteries, electrochemical flow batteries, energy storage flywheels or other known devices that can accumulate and/or generate electric energy.

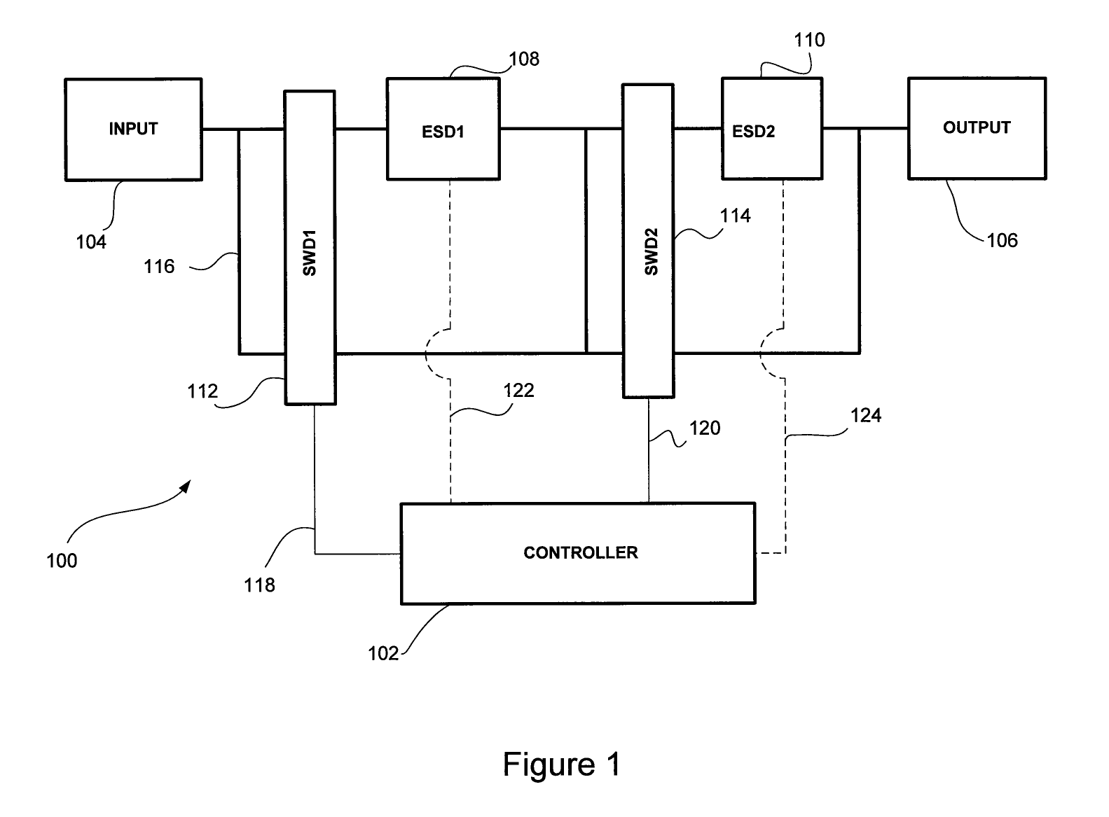

In FIG. 1, an exemplary embodiment of a control system 100 is provided for a series connection or circuit of a number of energy storage devices (e.g., electrochemical flow batteries). Individual battery cells connected in series can serve as an energy storage system for accumulating, storing or generating electric energy depending on a state of the system. As previously described, individual energy storage devices or battery cells of the control system 100 may vary from one to another in their characteristics due to imperfections in their respective manufacturing process or variations in characteristics of elements comprising individual cells such as electrolyte pumps, sensors, etc. In addition, the system 100 of energy storage devices connected in series may be distributed in space and therefore individual devices may experience various environmental forces such as temperature acting on them. Due to these variations between the energy storage devices, there can be differences in operational characteristics of these devices that can significantly influence performance and safety of the system 100. As a result, the embodiment of FIG. 1 provides the means of disabling individual devices coupled in an electrical current path and removing them from the flow path with minimal impact on the rest of the system 100.

Referring to FIG. 1, the system 100 can include an input 104 and an output 106 with an electrical current path or circuit 116 defined therebetween. The input 104 can be a source of current, for example, or another circuit. Likewise, the output 106 can be coupled to another circuit or system similar to the one shown in FIG. 1. The system 100 can include a plurality of energy storage devices coupled along the current path 116 between the input 104 and output 106. These devices can be electrochemical batteries, for example, or other known energy storage devices. In this embodiment, a first energy storage device 108 (“ESD1”) and a second energy storage device 110 (“ESD2”) are electrically coupled in series to one another in the circuit 116. A current can flow from the input 104 of the system 100 to the output 106 through each of the first energy storage device 108 and second energy storage device 110. In this manner, each energy storage device can be charged by passing current through the current path 116.

The control system 100 can also include a controller 102 and a network of switch devices. For instance, a first switch 112 (“SWD1”) and a second switch 114 (“SWD2”) are electrically disposed along the current path or circuit 116. As will be explained below, the switch devices can alter the current path through the circuit 116 such as the one in FIG. 1. The controller 102 is electrically coupled to the first switch device 112 via a first electrical connection 118 and the second switch device 114 via a second electrical connection 120. The controller 102 can also be electrically coupled to the first energy storage device 108 via optional electrical connection 122 and the second energy storage device 110 via optional electrical connection 124. The electrical connections 118, 120, 122, and 124 can include hardwire, wireless, Wi-Fi®, or other known electrical connection.

Through the electrical connections, the controller 102 can open or close one of the switch devices to alter the current path through the control system 100. In doing so, the controller 102 can effectively disable one of the energy storage devices such that a current passing through the circuit 116 is not received by the disabled device. The optional electrical connections 122, 124 can allow the controller 102 to communicate or receive information about one of the energy storage devices to allow the controller 102 to decide whether to open or close a switch device. For example, if the controller 102 receives information from the first energy storage device 108 via electrical connection 122 that the first energy storage device 108 is fully charged, the controller 102 can electrically control the first switch device 112 to alter the flow of current through the circuit 116 and disable the first energy storage device 108.

In another aspect, the control system 100 may be a battery management system formed by a circuit of individual batteries being electrically charged in series. Due to the series connection of individual batteries in the system, each will experience or receive the same electrical current during the charge process while the voltage applied to the terminals of the connection will be distributed between the individual devices. Due to imperfections and variations between the individual batteries, however, one or more of the batteries along the series connection may approach their maximum state of charge earlier than the others in the system. When electric current passes through a battery when it is fully charged, there can be undesirable losses in the system, degradation of battery characteristics, and safety issues. It may, however, still be desirable to charge the other batteries along the series connection which have not yet been fully charged. Thus, in order to continue charging and achieve a higher state of charge for the complete system, the “fully-charged” battery or batteries in the system can be disabled or disconnected from the current path defined in the system. An alternative current path for electric current can be provided in the system to continue charging the other battery or batteries.

In a related aspect, one or more batteries along a series connection may reach their target discharge state earlier than the rest of the devices in the system. In this instance, it may still be desirable to continue generating electric power by the system. Here, the controller 102 of the system 100 can disconnect these outliers from the system while providing an alternative flow path of current to the other devices in the system. In effect, the controller 102 of the battery management system 100 can monitor the state of charge of the individual battery cells in the series connection and decide which of the individual devices to disconnect from the network (i.e., circuit or current path 116). Thus, the controller 102 may decide to disconnect individual devices in order to prevent operation of these devices outside of their normal operational envelope, protect these devices from overcharge or overdischarge, and/or protect the devices and the rest of the system from local or external faults.

In another aspect of the present disclosure, a control system can comprises a series connection of one or more energy storage devices coupled to one another in a network of electronic switches and other passive devices that are capable of providing alternative flow paths for electric current passing through the system. The alternative current path can be formed by controlling the aforementioned switching devices between on and off states. Also, while only two energy storage devices and two switch devices are shown in the system of FIG. 1, another control system may have only one of each device or alternatively may include three or more of each device. In addition, there can be more than one controller, e.g., one controller for controlling the energy storage devices and another controller for controlling the switch devices. In this instance, the two controller can be in electrical communication with one another to control their respective devices for optimal system performance.

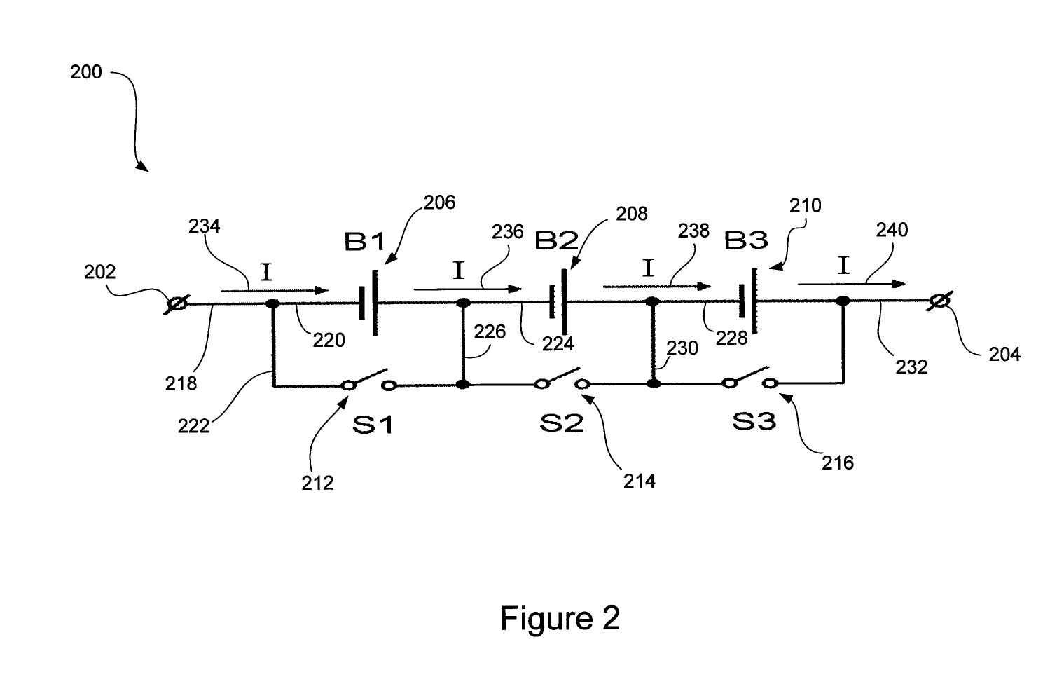

Referring to FIG. 2, an embodiment is shown of a control system 200 including a series connection of a plurality of energy storage devices. Each of the plurality of energy storage devices is identified by battery symbols, B1-B3, that are connected in series in an electrical circuit or current path. The energy storage devices, B1-B3, can be electrochemical batteries, electrochemical flow batteries, energy storage flywheels or other known devices that can accumulate and/or generate electric energy. In this particular embodiment, the system 200 includes a first battery 206, a second battery 208, and a third battery 210. The system can also include a network of switches, S1-S3, such as transistors. As shown, the system 200 includes a first switch 212 (“S1”), a second switch 214 (“S2”), and a third switch 216 (“S3”).

During normal operation of the system, a charge or discharge process can occur in which all energy storage devices 206, 208, 210 receive a current, I, passing through the circuit from an input 202 to an output 204. In this instance, the energy storage devices are coupled along a parallel connection with the first, second, and third switches disposed in an off position. As a result, the current can pass from the input 202 through a first current path 218 and a second current path 220 before being received by the first energy storage device 206. The current passes along a first direction indicated by arrow 234 in FIG. 2. The direction and path of the current may be determined by the impedance of this and alternative current paths. For example, since the first switch 212 is in an open position in FIG. 2, the impedance along the second current path 220 may be less than the impedance along a third current path 222. Thus, the current passes through the first energy storage device 206 in this instance.

As the current passes through the input and output terminals of the first energy storage device 206, the current continues passing along a second direction indicated by arrow 236 through a fourth current path 224. The current can thus pass through the input and output terminals of the second energy storage device 208. Here, the impedance along the fourth current path is less than the impedance along a fifth current path 226 because the second switch 214 is disposed in an open position. As a result, the current passes through the output of the second energy storage device 208 and along a sixth current path 228 in a direction indicated by arrow 238.

As the current flows along the sixth current path 228, the current is received by the third energy storage device 210. Again, the impedance of the sixth current path 228 may be less than the impedance of a seventh current path 230 due to the third switch 216 being in an open position. As the current passes through the input and output terminals of the third energy storage device 210, the current continues along an eighth current path 232 in a direction indicated by arrow 240. In this embodiment, the current passes through each of the energy storage devices along a substantially linear path. With each of the switches being in an open position, the arrangement of the energy storage devices is defined as a series connection.

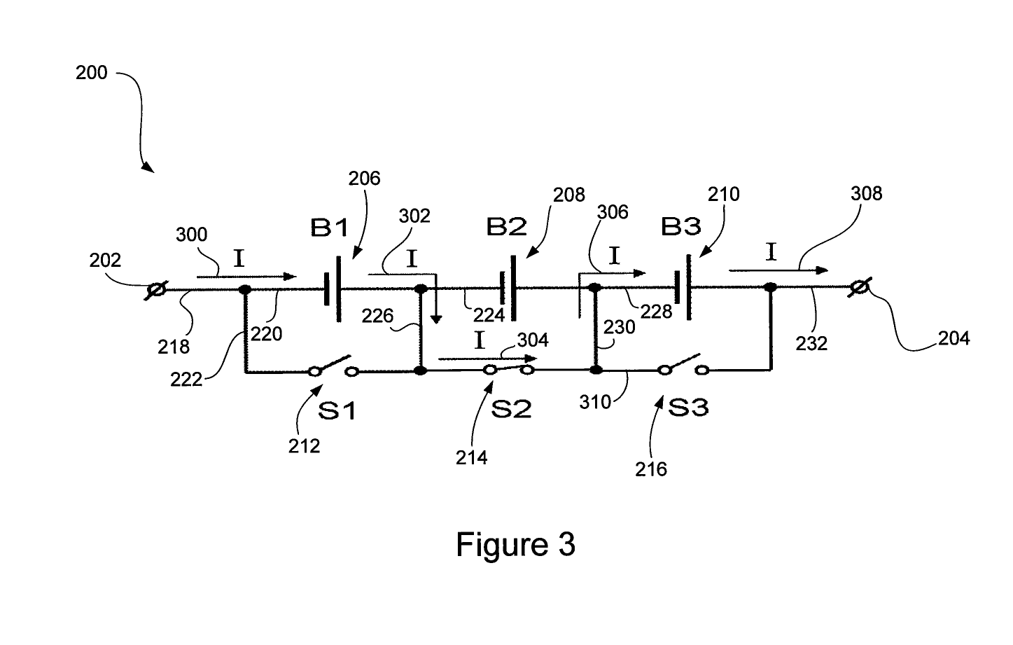

An alternative embodiment of the control system 200 is shown in FIG. 3. Here, a controller (not shown) may determine that one of the energy storage devices needs to be removed or disabled from the series connection. In FIG. 3, for example, the second switch 214 is moved to a closed position and thereby forming an alternative electrical current path through the system 200. A current can flow from the input 202 in a first direction indicated by arrow 300. The current passes through the first current path 218 and second current path 220, as shown. The first energy storage device 206 receives the current since the first switch 212 is in the open position.

With the second switch 214 being disposed in the closed position, an alternative current path can be formed through the system 200. The impedance along the fourth current path 224 may now be greater than the impedance along the fifth current path 226. As such, the current flows in a direction indicated by arrow 302 along the fifth current path 226, thereby bypassing the second energy storage device 208. With the second switch 214 closed, the current passes through the switch 214 along a direction indicated by arrow 304.

In FIG. 3, the third switch 216 remains in an open position and thus the impedance through the seventh current path 230 may be less than the impedance through a ninth current path 310. The current therefore flows along a direction indicated by arrow 306 and through the sixth current path 228. The third energy storage device 210 receives the current before the current reaches the output 204 of the system 200. In this embodiment, due to the alternative current path of the current, there may be a different distribution of voltage and current between the first energy storage device 206 and third energy storage device 210 disposed along the series connection. It may be necessary and/or desirable to regulate the voltage on the terminals of the series connection with external means in order to guarantee optimal operation of the system 200.

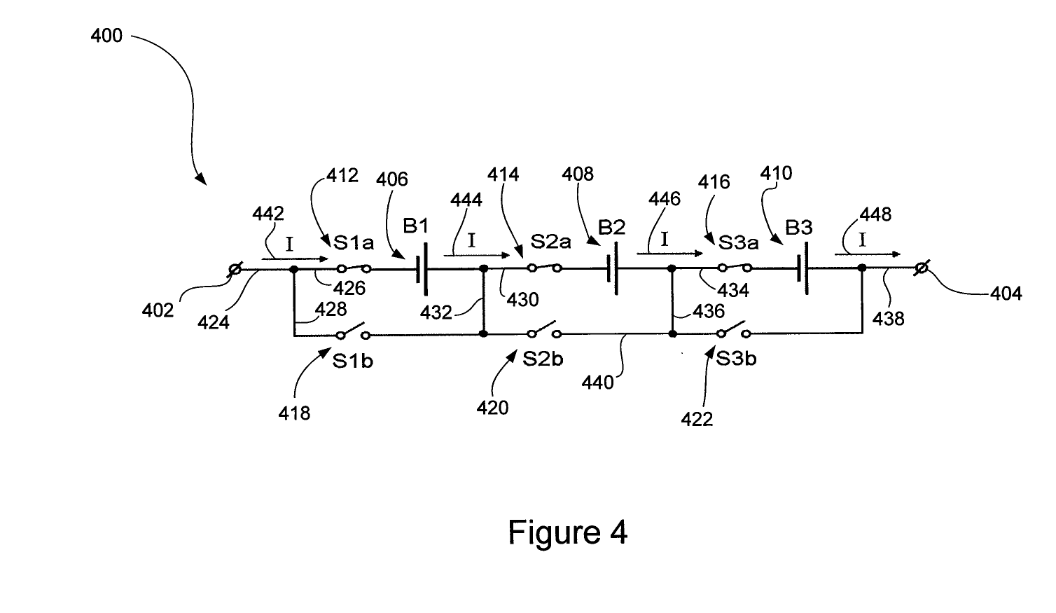

In the embodiment of FIG. 3, the alternative current path was formed due to the difference in impedances between two adjoining electrical current paths. However, in some instances, the difference in impedances may be small such that the current does not follow the alternative current path. In other words, if the impedance of the energy storage devices connected in series is low and comparable to the impedance of the alternative current path through the switches, additional switches can be incorporated into the system to remove one or more of the energy storage devices from the current path. An exemplary embodiment of this is illustrated in FIG. 4. As shown, each energy storage device is electrically coupled to an additional switch device.

Referring to FIG. 4, a control system 400 can include an electrical circuit defined by a plurality of electrical current paths formed between an input source 402 and an output 404. A first energy storage device 406, a second energy storage device 408, and a third energy storage device 410 can be electrically configured in series along the circuit between the input 402 and output 404. In addition, each energy storage device can include two or more switch devices to improve the controllability of the respective energy storage device. For instance, current passing through the first energy storage device 406 can be controlled by a first switch device 412 and a second switch device 418. Likewise, current passing through the second energy storage device 408 can be controlled by a third switch device 414 and a fourth switch device 420. Current passing through the third energy storage device 410 can be controlled by a fifth switch device 416 and a sixth switch device 422.

As described, the circuit is defined by a plurality of current paths. With the first switch 412, third switch 414, and fifth switch 416 closed and the second switch 418, fourth switch 420, and sixth switch 422 open, the current paths include a first current path 424, a second current path 426, a third current path 428, a fourth current path 430, a fifth current path 432, a sixth current path 434, a seventh current path 436, and an eighth current path 438. In this embodiment, a current can flow along a linear path between the input 402 and output 404 defined by arrows 442, 444, 446, and 448. This linear current path therefore includes the first current path 424, second current path 426, fourth current path 430, sixth current path 434, and eighth current path 438. The current can follow this linear path so long as the first switch 412, third switch 414, and fifth switch 416 are disposed in closed positions. One reason for this can be attributed to the differences in impedance values between the second current path 426 and third current path 428, fourth current path 430 and fifth current path 432, and sixth current path 434 and seventh current path 436, respectively.

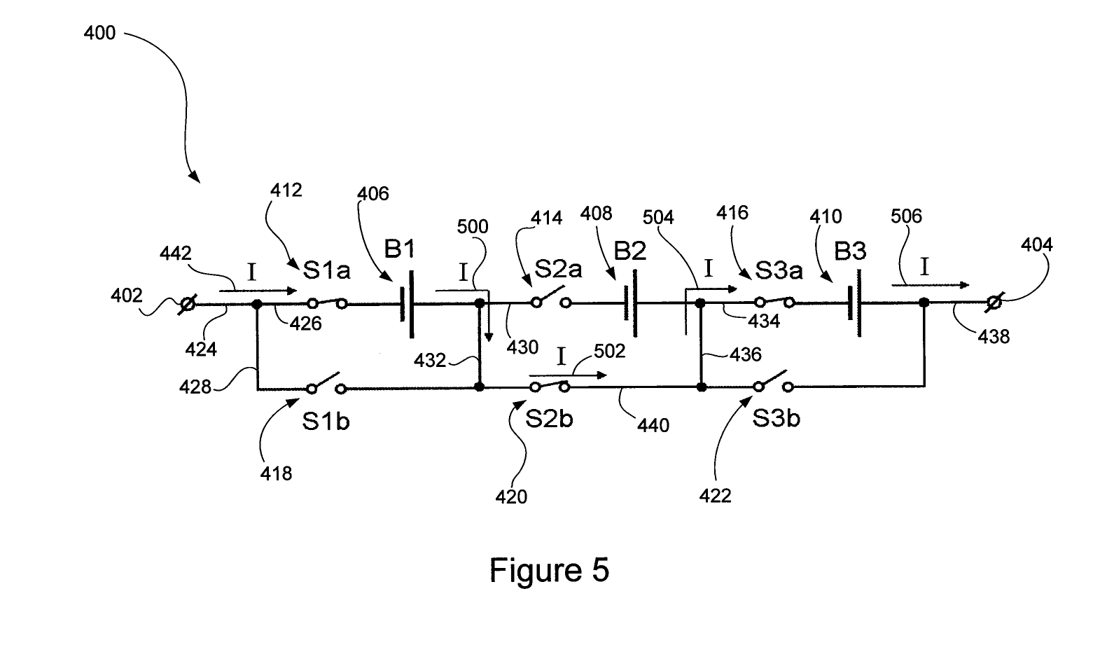

A situation may arise where the second energy storage device 408 needs to be disabled or removed from receiving the current. An example of this is shown in FIG. 5. To do so, the third switch 414 and fourth switch 420 can be controlled to alter the path of the current through the circuit. In particular, a controller (not shown) can control the third switch 414 from the closed position to an open position and the fourth switch 420 from the open position to a closed position. In this configuration, the current passes along a direction identified by arrow 500 through the fifth current path 432 instead of the fourth current path 430. In doing so, the current bypasses the second energy storage device 408 and passes through the fourth switch 420 along a direction indicated by arrows 502 and 504. With the sixth switch 422 being open, the impedance is such that the current is directed along a ninth current path 440, seventh current path 436 and sixth current path 434. The current then passes through the fifth switch 416 and is received by the third energy storage device 410. The current then continues to the output 404 of the system 400 along a direction indicated by arrow 506.

In the embodiment of FIG. 4, the current path from the input 402 to the output 404 is illustrated as being linear but this may not be the case in every embodiment. The energy storage devices 406, 408, 410 are arranged in a series connection as shown. The switch devices are configured in a parallel construction to the energy storage devices, but in other embodiments these devices can be arranged differently (e.g., in series). In addition, the embodiment of FIGS. 4 and 5 is structured to include twice as many switch devices per energy storage device than the embodiment in FIGS. 2 and 3. With additional switch devices per energy storage device, the system can provide a higher degree of control authority over the current flow through the series connection. Although in FIGS. 4 and 5 there are two switch devices for every energy storage device, in alternative embodiments there can be three or more switch devices per energy storage device. This may be particularly true in more complex circuits with multiple energy storage devices, some of which may be of a different type (e.g., electrochemical battery and flywheel).

The performance requirement of each switch device in the previously described embodiments can be modest since each device is not required to perform modulation. Instead, each switch device is controlled between on and off positions in a particular network connection in the system. As a result, it is possible to include inexpensive electronic switches such as transistors for the above purposes so long as the current and voltage requirements of the series connection are fulfilled.

The above control scheme can be further enhanced by introducing additional storage devices into the series connection that are bypassed through corresponding switch devices during normal operation of the system. These additional energy storage devices can then be enabled or turned on and added to the series connection only when a controller determines that other devices need to be disabled for various reasons. This may result in the extension of the normal operation of the system with a fixed number of active or enabled energy storage devices at any given instant of time at the expense of having additional devices that are not constantly operable or active. This configuration may be desirable in control systems that rely on constant or approximately constant voltage on the terminals of the system because removing one of the storage devices from the series connection may result in the drop of voltage on the terminals. By simultaneously removing one or more of the energy storage devices and activating or enabling an equal number of similar energy storage devices, the voltage can be maintained on the terminals of the system near a normal operating value.

The embodiments of the present disclosure can be implemented on various levels of the system architecture. For instance, the energy storage devices in FIGS. 2-5 can represent complete energy storage units containing multiple individual energy storage cells/elements. Alternatively, these energy storage devices can comprise a series connection of energy storage cells within a larger storage unit. The individual storage devices, for example, can be implemented with electrochemical flow batteries where each battery contains a stack of electrodes connected in series. The proposed architecture can then be used on two different levels. On a first or lower level, it can be implemented to control the current flowing through pairs of electrodes connected in series within the stack of the battery. On a second or higher level, it can be used to control the current flowing through a string of complete batteries connected in series.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An energy storage control system, comprising:
a controller;
a circuit defining a plurality of electrical current paths between an input and an output;
a first energy storage device and a second energy storage device electrically coupled in series to one another between the input and output;
a first switch device electrically coupled in parallel to the first energy storage device; and
a second switch device electrically coupled in parallel to the second energy storage device;
wherein, the controller is in electrical communication with the first energy storage device and the second energy storage device;
further wherein, the first switch device and second switch device are operably controlled by the controller.

2. The energy storage control system of claim 1, further comprising:
a first current path defined between the input and output and in electrical communication with the first energy storage device and second energy storage device; and
a second current path electrically coupled between the first current path and one of the first switch device and second switch device.

3. The energy storage control system of claim 2, wherein the first energy storage device and second energy storage device are configured to receive a current passing through the first current path.

4. The energy storage control system of claim 3, wherein the first switch device and second switch device are disposed in an open position.

5. The energy storage control system of claim 2, wherein the first switch device or the second switch device is configured to receive a current passing through the second current path.

6. The energy storage control system of claim 2, wherein when the first switch device is disposed in a closed position, the first energy storage device is electrically disconnected from the input.

7. The energy storage control system of claim 6, wherein a current passes through the second current path.

8. The energy storage control system of claim 2, wherein when the second switch device is disposed in a closed position, the second energy storage device is electrically disconnected from the input.

9. The energy storage control system of claim 8, wherein a current passes through the second current path.

10. The energy storage control system of claim 1, further comprising:
a third energy storage device electrically coupled in series with the first and second energy storage devices; and
a third switch device electrically coupled in parallel to the third energy storage device.

11. The energy storage control system of claim 1, further comprising a third switch device electrically coupled in series with one of the first energy storage device and second energy storage device.

12. The energy storage control system of claim 1, wherein the first and second energy storage devices comprise an electrochemical battery, an electrochemical flow battery, or an energy storage flywheel.

13. An energy storage management system, comprising:
a controller;
a circuit including an input and an output;
a first energy storage device and a second energy storage device electrically coupled in series to one another between the input and output;
a first and second switch electrically coupled in parallel to the first and second energy storage devices; and
a third switch electrically coupled in series with the first energy storage device and a fourth switch electrically coupled in series with the second energy storage device;
wherein, the controller is in electrical communication with the first energy storage device and the second energy storage device;
further wherein, the first, second, third, and fourth switches are operably controlled between open and closed positions by the controller.

14. The energy storage management system of claim 13, further comprising a first electrical current path defined in the circuit;
wherein, the input, output, first energy storage device, second energy storage device, third switch, and fourth switch are in electrical communication with one another along the first electrical current path;
further wherein, a current passes through the first electrical current path when the third and fourth switches are disposed in the closed position and the first and second switches are disposed in the open position.

15. The energy storage management system of claim 14, further comprising:
a second electrical current path defined in the circuit;
wherein, the current passes through the second electrical current path when:
(a) the first and fourth switches are in closed positions and the second and third switches are in open positions; or
(b) the second and third switches are in closed positions and the first and fourth switches are in open positions; or
(c) the first and second switches are in closed positions and the third and fourth switches are in open positions.

16. A method of controlling an energy storage device system, comprising:
providing a circuit having an input and an output, a first and second energy storage device electrically coupled to one another in series between the input and output, and a first and second switch electrically coupled in parallel with the first and second energy storage devices;
passing a current through an electrical current path from the input to the output;
receiving information about each of the first and second energy storage devices; and
determining whether to change the current path through which the current passes in response to the information received.

17. The method of claim 16, further comprising changing the path of the current in response to the information received.

18. The method of claim 17, wherein the changing step comprises opening or closing the first or second switch.

19. The method of claim 16, further comprising:
receiving the current by the first and second energy storage devices;
storing electrical energy in the first and second energy storage devices until the amount of stored energy in at least one of the first and second energy storage devices reaches a desired amount;
determining that the amount of stored energy in at least one of the first and second energy storage devices has reached the desired amount; and
controlling the first or second switch to electrically disable the energy storage device from receiving the current once it has reached its desired energy storage amount.

20. The method of claim 19, further comprising passing the current through an alternative current path.
